(19) United States
(12) Patent Application Publication
(10) Pub. No.: US 2025/0211853 A1
(43) Pub. Date: Jun. 26, 2025

(54) METHOD FOR LENS BREATHING COMPENSATION IN CAMERA SYSTEMS

(71) Applicant: Advanced Micro Devices, Inc., Santa Clara, CA (US)

(72) Inventors: Wei-Chih Hung, Hsinchu (TW); Yu-Huai Chen, Hsinchu (TW)

(21) Appl. No.: 18/395,484

(22) Filed: Dec. 23, 2023

(51) Int. Cl. H04N 23/67; G02B 7/36; H04N 5/262

(52) U.S. Cl. CPC H04N 23/67; G02B 7/36; H04N 5/2628

(57) ABSTRACT

An apparatus and method for efficiently performing auto focusing while reducing lens breathing are contemplated. In various implementations, an image sensor of a camera system captures optical images of a scene and converts the optical signals into electrical signals. One or more of an auto focus circuit and an image signal processing circuit converts the analog electrical signals into digital signals. The auto focus circuit instructs a lens controller to move the lens to multiple lens positions until a final lens position is found. To reduce lens breathing during the auto focusing steps, a compensation accesses multiple compensation ratios calculated during an offline calibration process and generates updated 10 radial distances of the current lens position using the multiple compensation ratios. The compensation circuit also provides warp vectors based on the updated radial distances to a warping circuit that reduces distortion.

### BACKGROUND

### Description of the Relevant Art

Both still cameras and video cameras capture optical images of a particular scene, and these images are converted into electrical signals such as digital data. For example, the camera includes an image sensor that captures the optical image and converts this information into analog electrical signals. An analog-to-digital converter (ADC) converts the analog electrical signals into digital electrical signals. The components of the camera are capable of editing the digital data and storing the digital data. In various cases, the components encode, or compress, the digital data. In some cases, the stored digital data is uploaded to another computing system for data processing such as editing. Prior to performing these operations, the components of the camera attempt to capture a high-quality image for the user.

Although in some cases, a user purposely performs over- or underexposure of a scene or creates blurring of a captured image for a particular effect, typically, users prefer a captured image of a scene with highly visible details. For example, the objects in the scene are easily discernible in the captured image when the digital data is rendered and presented on a display for viewing. One of the many factors that contribute to capturing a detailed and clear image is focus. A camera's “focus” refers to a particular lens displacement of multiple lens displacements of the camera that provides an optical image of a particular scene with the smallest amount of blur. In other words, the particular lens displacement provides an optical image of the particular scene with the highest amount of contrast, or the sharpest image. The lens displacement is measured between the camera lens and the image sensor of the camera.

Rather than rely on the user to determine the particular lens displacement, many cameras provide an automatic method implemented by hardware for finding the particular lens displacement. This automatic method is referred to as “auto focus.” The auto focus method of cameras changes the camera lens position multiple times until the particular lens displacement is found. Each of these multiple lens positions have a corresponding magnification of the image, which causes an effect of zooming in on the image and zooming out from the image. This zooming in and zooming out effect based on magnification as the lens position changes is referred to as “lens breathing.” Lens breathing is undesirable, especially for video applications, because lens breathing annoys can distract a user's attention when they shoot or watch videos. This distraction lowers the quality of the videos.

In view of the above, methods and mechanisms for efficiently performing auto focusing while reducing lens breathing are desired.

### BRIEF DESCRIPTION OF THE DRAWINGS

FIG. 1 is a generalized diagram of one implementation of an image signal processing system that efficiently performs auto focusing while reducing lens breathing.

FIG. 2 is a generalized diagram of one implementation of relationships between lens position and auto focus values.

FIG. 3 is a generalized diagram of one implementation of relationships between lens position and image magnification.

FIG. 4 is a generalized diagram of one implementation of an apparatus that efficiently performs auto focusing while reducing lens breathing.

FIG. 5 is a generalized diagram of one implementation of warping correction.

FIG. 6 is a generalized diagram of one implementation of radial distance correction.

FIG. 7 is a generalized diagram of one implementation of radial distance correction.

FIG. 8 is a generalized diagram of one implementation of a method for efficiently determining a final camera lens position that captures a focused input image.

FIG. 9 is a generalized diagram of one implementation of a method for performing offline calibration to generate magnification scaling factors used later by auto focus steps that reduce lens breathing.

FIG. 10 is a generalized diagram of one implementation of a method for efficiently performing auto focusing while reducing lens breathing.

FIG. 11 is a generalized diagram of one implementation of a method for efficiently performing auto focusing while reducing lens breathing.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Apparatuses and methods efficiently performing auto focusing while reducing lens breathing are contemplated. In various implementations, a camera system includes a camera lens, an image sensor, a lens controller, an auto focus circuit, and an image signal processing circuit. The image sensor captures optical images of a scene and converts the optical signals into electrical signals. One or more of the auto focus circuit and the image signal processing circuit converts the analog electrical signals into digital signals. The auto focus circuit includes one of a variety of filters that generates, or otherwise calculates, an auto focus value. As used herein, an “auto focus value” is also referred to as a “contrast value” or a “sharpness value.” Based on the auto focus values, the auto focus circuit determines the next lens position for the camera lens and sends an indication of this next lens position to the lens controller. The lens controller updates the lens position of the camera lens. This update changes the lens displacement between the camera lens and the image sensor. Accordingly, the discernibility of the objects in the scene as captured in the next optical image changes. These steps repeat until the auto focus circuit determines a final lens position has been found.

During the auto focusing steps, each of the multiple lens positions has a corresponding magnification of the image, which causes an effect of zooming in on the image and zooming out from the image. This zooming in and zooming out effect based on magnification as the lens position changes is referred to as “lens breathing.” To reduce lens breathing, the image signal processing circuit receives a presently used camera lens position of the camera lens from the lens controller and accesses multiple compensation ratios corresponding to the received camera lens position. The image signal processing circuit generates updated radial distances across the input image based on the accessed compensation ratios. The image signal processing circuit generates multiple warp vectors based on the updated radial distances across the input image. The image signal processing circuit sends the multiple warp vectors to a warping circuit.

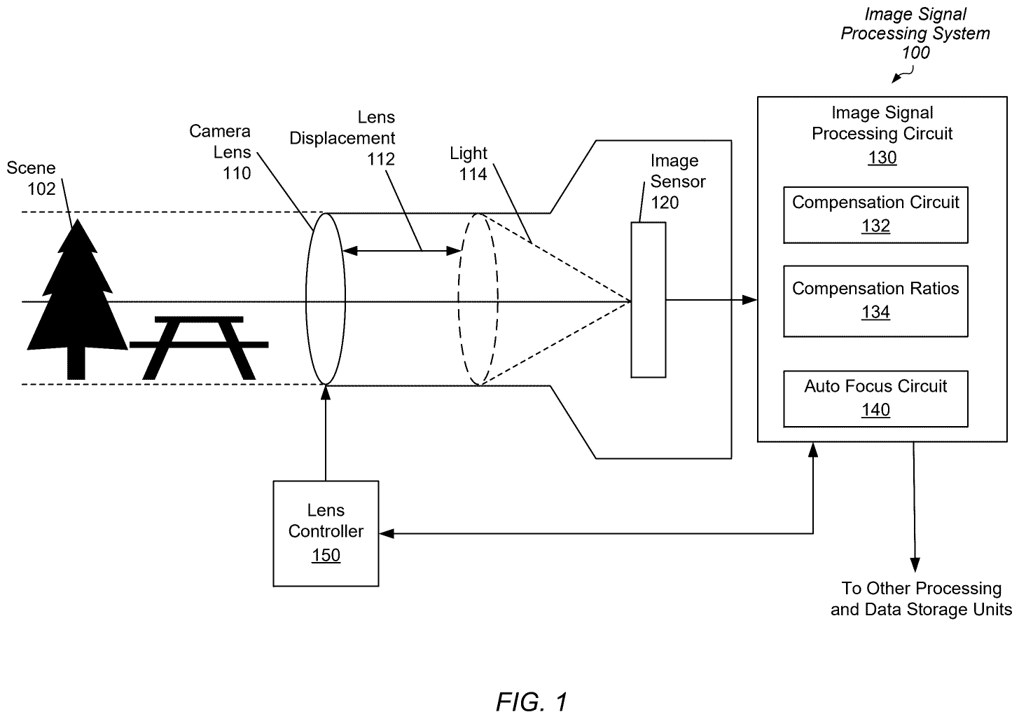

In various implementations, the compensation ratios were calculated during an offline calibration process. These compensation ratios are stored in data storage by the image signal processing circuit. The image signal processing circuit generates updated radial distances of the current lens position using the multiple compensation ratios. In an implementation, the image signal processing circuit multiplies each of the radial distances by a corresponding compensation ratio. This compensation ratio has a value based on the particular radial distance and the presently used lens position. By updating the radial distances of the presently used lens position, the image signal processing circuit reduces lens breathing while performing auto focusing. Further details of these techniques to perform auto focusing while reducing lens breathing are provided in the following description of FIGS. 1-11.

Turning to FIG. 1, a generalized diagram is shown of one implementation of an image signal processing system 100 that efficiently performs auto focusing while reducing lens breathing. As shown, the image signal processing system 100 of a camera capable of performing automatic focus includes a camera lens 110, an image sensor 120, an auto focus circuit 140, and a lens controller 150. In an implementation, the functionality of the image signal processing circuit 130 is performed by a single processing circuit (or processor), whereas, in another implementation, the functionality of the image signal processing circuit 130 is performed by multiple processing circuits. The functionality of the image signal processing circuit 130 is representative of the functionality of one or more of a general-purpose central processing unit (CPU), a processor with a parallel data microarchitecture such as a graphics processing unit (GPU), or a digital signal processor (DSP), an application specific integrated circuit (ASIC), or other.

The image signal processing circuit 130 sends control signals and data to one or more external components. The external components include other components of the camera and peripheral devices. These external components are capable of compressing the digital data, editing the digital data, and storing the digital data. Prior to performing these operations, the image signal processing system 100 of the camera attempts to capture a high contrast image for the user while reducing lens breathing. It is noted that the above subcomponent auto focus circuit 140 is implemented with hardware, such as circuitry, to perform the above steps to select lens positions for the camera lens 110.

The image sensor 120 captures optical signals, such as light 114 (or light waves), that pass through the camera lens 110. For example, the optical signals corresponding to scene 102 are captured by the camera lens 110 and transmitted to the image sensor 120. The optical signals are light waves that reflect off of one or more objects in scene 102. The lens displacement 112 is the distance between the camera lens 110 and the image sensor 120. The lens controller 150 adjusts the lens position of the camera lens 110, which adjusts the lens displacement 112. The auto focus circuit 140 sends an indication to the lens controller 150 specifying the next lens position for the camera lens. The auto focus circuit 140 calculates the lens position based on processing digital signals corresponding to a captured image of scene 102 while the camera lens 110 is at a current lens position.

In some implementations, the image sensor 120 is a charge-coupled device (CCD) based on metal oxide semiconductor (MOS) capacitors. In other implementations, the image sensor 120 is a CMOS sensor (complementary metal oxide semiconductor sensor) based on active transistors such as MOS field effect transistors (FETs). The image sensor 120 converts the optical signals into analog electrical signals. One or more of the auto focus circuit 140 and the image signal processing circuit 130 converts the analog electrical signals into digital electrical signals. For example, an analog-to-digital converter (ADC) converts the analog electrical signals into digital electrical signals. In some implementations, the lens controller 150 is a VCM (Voice Coil Motor) actuator that controls the lens position of the camera lens 110 via a spring mechanism.

In some implementations, the auto focus circuit 140 is incorporated within the image signal processing circuit 130. In other implementations, the auto focus circuit 140 and the image signal processing circuit 130 are separate components that communicate with one another. As used herein, an “auto focus value” is also referred to as a “focus value,” a “contrast value” or a “sharpness value.” The focus values are based on pixel intensity values of the digital signals. The auto focus circuit 140 generates a focus value (or contrast value) that indicates the multiple differences between the multiple pixel intensity values across the captured image corresponding to a particular value of the lens displacement 112. The auto focus circuit 140 calculates focus values based on the digital electrical signals (or digital signals).

To determine whether a captured image is in focus, or has high contrast, the auto focus circuit 140 calculates differences between pixel intensity values of adjacent pixels. When one or more objects of the scene 102 are out of focus and appear blurry to the user when the corresponding digital image data is sent to a display (not shown), the corresponding pixel intensity values of objects in the captured image corresponding to the scene 102 have similar values. The auto focus circuit 140 determines how to adjust the lens displacement 112 in order to cause the one or more objects of scene 102 to be in focus and appear sharp to the user when the corresponding digital image data is sent to the display. In such a case, the corresponding pixel intensity values of objects in the captured image have maximum or near-maximum differences.

In some implementations, the auto focus circuit 140 includes one of a variety of filters such as an infinite input response (IIR) filter, a finite impulse response (FIR) filter, a Gaussian filter, a Laplacian filter, and so forth that generates, or otherwise calculates, the contrast value. These various filters are capable of being configured to operate as a bandpass filter or a high pass filter. As the contrast value increases, the differences in pixel intensity values of adjacent pixels increase, and the objects in the captured image are more easily discernible when the digital data is rendered and presented on the display for viewing. The auto focus circuit 140 of cameras changes the camera lens position multiple times until the particular lens displacement is found. Each of these multiple lens positions have a corresponding magnification of the image of scene 102, which causes an effect of zooming in on the image and zooming out from the image. This zooming in and zooming out effect based on magnification as the lens position changes is referred to as “lens breathing.” Lens breathing is undesirable, especially for video applications, because lens breathing annoys can distract a user's attention when they shoot or watch videos.

At a current lens position of the camera lens 110, the compensation circuit 132 generates a first set of multiple radial distances where each radial distance is measured from a center of the image data of scene 102 to a corresponding point of multiple points within the image data. The compensation circuit 132 accesses the compensation ratios 134 and generates a second set of multiple radial distances. In some implementations, each of the compensation ratios 134 is a scaling factor between multiple radial distances of a reference lens position and multiple radial distances of the current lens position. For example, each of the compensation ratios 134 is a ratio of one of multiple radial distances in scene 102 corresponding to the image data at a first reference lens position to a corresponding one of multiple radial distances in scene 102 at the first lens position. In some implementations, the first reference lens position is a macro lens position corresponding to a minimum focus distance and a maximum magnification of image data of scene 102. In other implementations, the first reference lens position is another camera lens position.

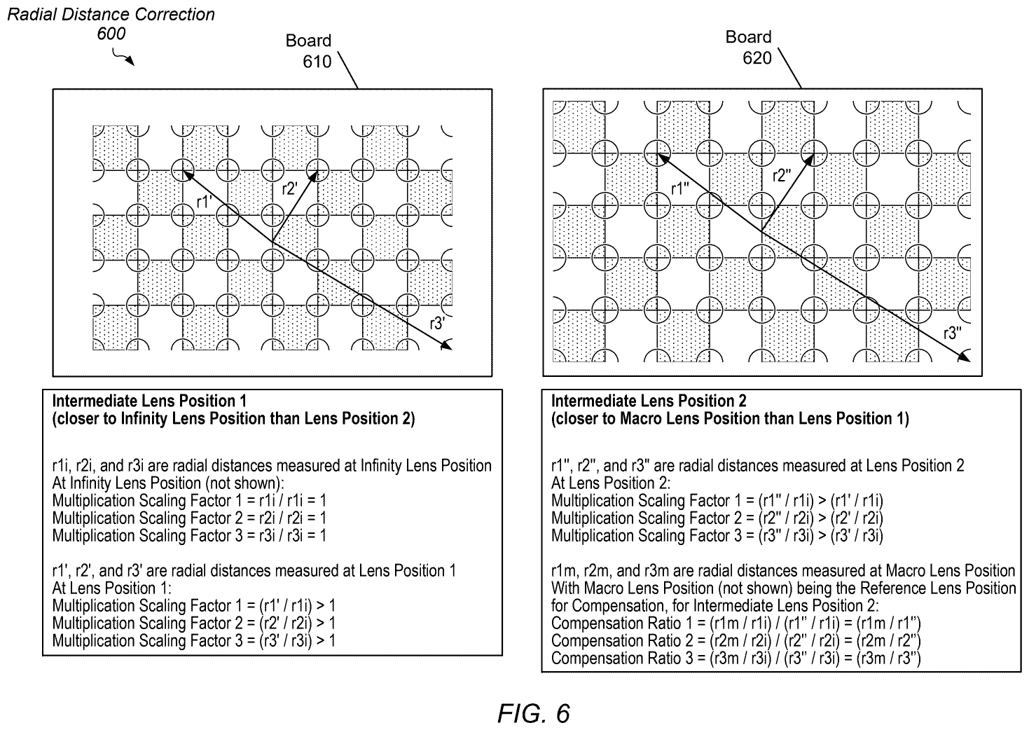

In other implementations, each of the compensation ratios 134 is a ratio of one of multiple multiplication scaling factors at the first reference lens position to a corresponding one of multiple multiplication scaling factors at the first lens position. Any magnification scaling factor is a ratio of a radial distance in scene 102 at a given lens position to a corresponding radial distance in scene 102 at a second reference lens position. In an implementation, the second reference lens position is an infinity lens position corresponding to a maximum focus distance and a minimum magnification of an image. In other implementations, the second reference lens position is another camera lens position. Further details of calculating the compensation ratios is provided in the description of radial distance correction 600 (of FIG. 6).

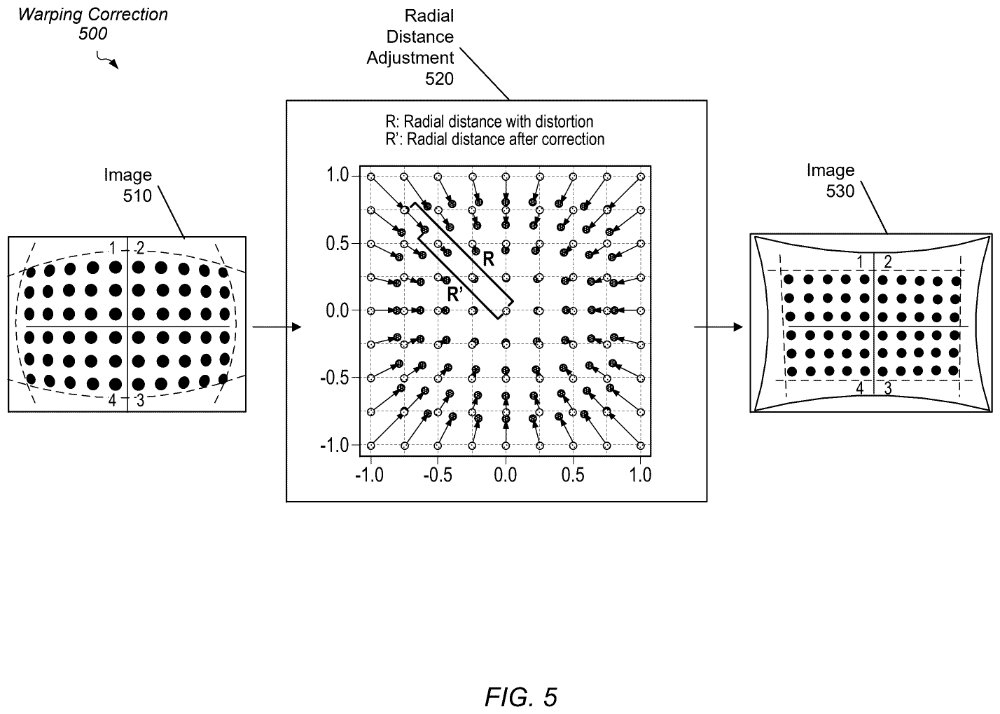

The compensation ratios 134 are generated during an offline calibration process that measures magnification of radial distances of an image for different lens positions. The compensation circuit 132 maintains data storage of the compensation ratios 134. Compensation circuit 132 generates updated radial distances across scene 102. In some implementations, compensation ratios 134 include updated warp vectors used to locate points on a warping grid. Further details of updating warping vectors used by a warping grid are provided in the description of warping correction 500 (of FIG. 5). First, a further description of the auto focus steps and the image signal processing pipeline are provided in the description of FIGS. 1-4.

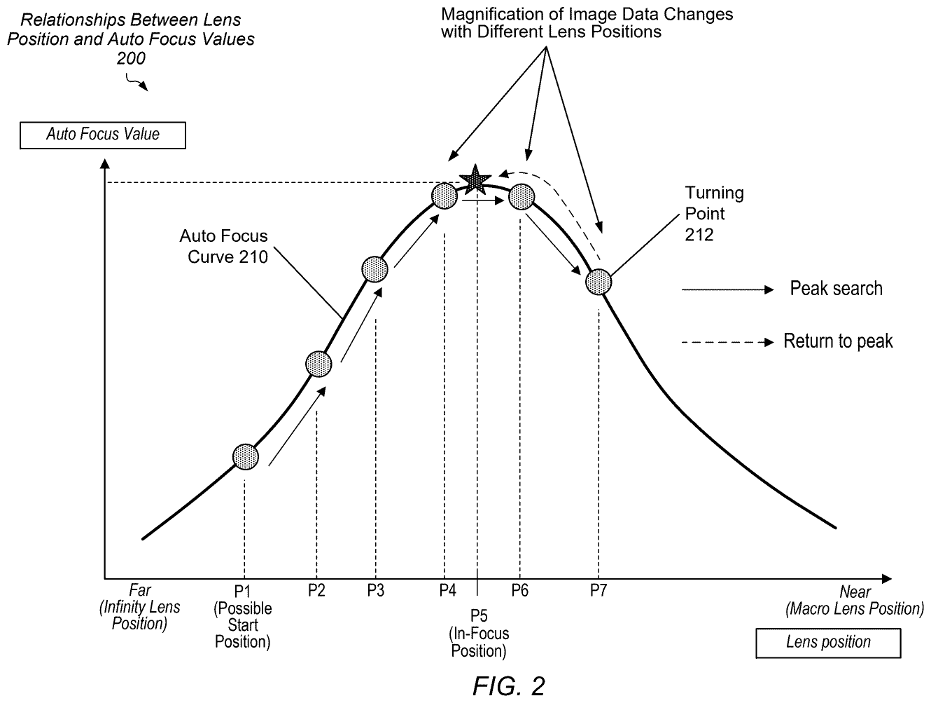

Referring to FIG. 2, a generalized diagram is shown of relationships 200 between lens position and auto focus values is shown. As described earlier, light waves reflected from objects in scene 102 (of FIG. 1) are captured and converted to digital electrical signals, which are input to a bandpass filter of the auto focus circuit 140 (of FIG. 1). As shown, the auto focus curve 210 illustrates a relationship between lens position of a camera lens and contrast values of a captured image calculated at the lens positions. The y-axis includes the auto focus values (contrast values) and the x-axis includes the lens positions. The auto focus curve 210 indicates calculated auto focus values (contrast values) of the captured image of scene 102 calculated by the auto focus circuit 140 at different lens positions. Although a contrast-based auto focus process is shown, it is noted that any auto focus process can be used and the changing of lens positions still occurs. The changing of lens positions can cause lens breathing when compensation is not used.

The left side of the x-axis corresponds to a lens position used to increase contrast of an object in a scene located at a very far or infinite distance from the camera. The right side of the x-axis corresponds to a lens position used to increase contrast of an object in a scene located at a very near or closest distance from the camera. Seven lens positions are shown on the x-axis labeled P1 to P7. The measurement units and values of the lens positions P1 to P7 are selected based on design requirements. The auto focus curve 210 has a peak auto focus value at lens position P5. A possible start lens position is at lens position P1 and six search states are also shown. Although a particular start lens position is shown beginning at lens position P1 near the far-left side of the x-axis, it is possible for any location on the x-axis to be the start position for searching for the final lens position at lens position P5.

The first search state occurs at lens position P1 when an auto focus circuit determines the search direction is moving left on the x-axis or moving right on the x-axis from the start position. The auto focus circuit determines the search direction for moving the camera lens based on comparing contrast values of a same focus curve (generated by a same filter) at two different lens positions, which indicates whether the slope of the focus curves between the two lens positions is increasing or decreasing. The slope, or a ratio, is a first difference of two contrast values divided by a second difference of two lens positions that include a most recent (second) lens position and an immediately previous (initial) lens position. The slope changes from increasing to decreasing by more than a threshold, and the auto focus circuit found the turning point 212. After turning point 212 is found, one or more subsequent search states are calculated. At each of the search states corresponding to different lens positions, such as lens positions P1 to P7, the magnification of the image data of scene 102 changes. These magnification changes cause lens breathing. As described earlier, a compensation circuit can use magnification scaling factors found during offline calibration to update radial distances of the image data to reduce lens breathing.

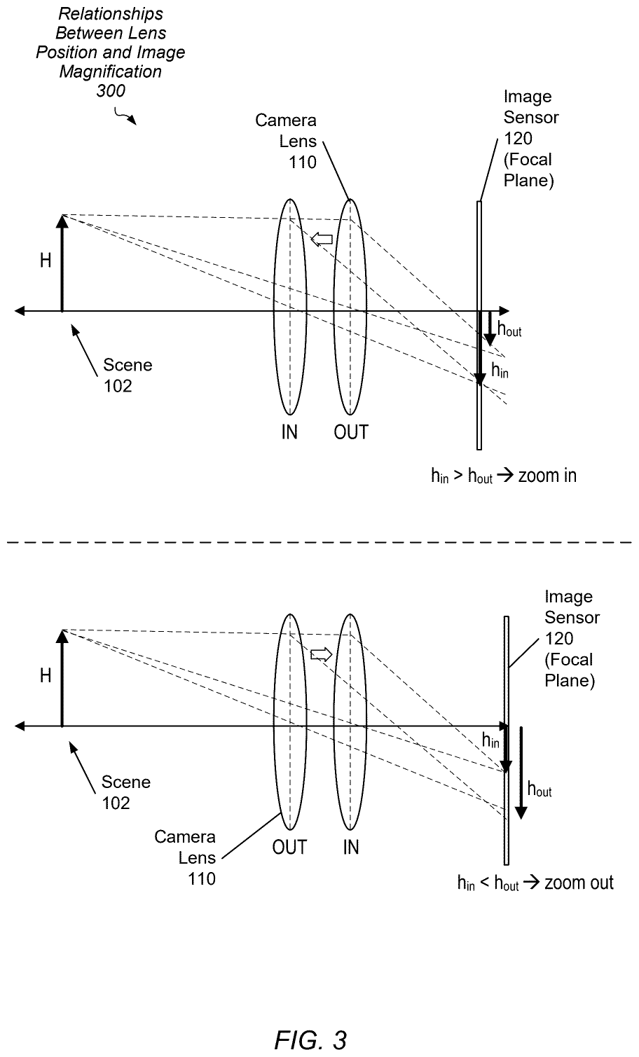

Turning now to FIG. 3, a generalized diagram is shown of one implementation of relationships 300 between lens position and image magnification. Circuits and components previously described are numbered identically. Scene 102 includes an image with a height indicated by “H” and the camera lens 110 is shown moving between two lens positions. In the top half of the figure, a lens controller (not shown) transitions the camera lens 110 from a lens position indicated as “OUT” to a lens position indicated as “IN.” The image sensor 120, which is the focal plane, captures optical signals, such as light 114 (or light waves), that pass through the camera lens 110 and converts the optical signals into analog electrical signals. As shown, the height of the image of scene 102 is indicated as “hout” when the camera lens is at the lens position indicated as “OUT.” The scene 102 is out of focus when the camera lens 110 is at the lens position indicated as “OUT.” The inverted image at the image sensor 120 forms an unclear image with the height hout. When the lens controller moves the camera lens 110 to the lens position indicated as “IN,” the height of the image of scene 102 is indicated as “hin.” The scene 102 is in focus when the camera lens 110 is at the lens position indicated as “IN.” The inverted image at the image sensor 120 forms a clear image with the height hin. Since the height hin is greater than the height hout, the image looks like it is being zoomed in while the auto focus circuit (not shown) performs focusing.

In the bottom half of the figure, the lens controller (not shown) transitions the camera lens 110 from the lens position indicated as “IN” to the lens position indicated as “OUT.” For example, the user of the camera prefers to focus on a different object of the image data of scene 102 such as a picnic table in the foreground, rather than a tree in the background, or vice-versa. As shown, the height of the image of scene 102 is indicated as “hin” when the camera lens is at the lens position indicated as “IN.” The currently selected object of scene 102 is in focus when the camera lens 110 is at the lens position indicated as “IN.” The inverted image at the image sensor 120 forms a clear image with the height hin. This object of scene 102 is out of focus when the camera lens 110 is at the lens position indicated as “OUT.” The inverted image at the image sensor 120 forms an unclear image with the height hout. When the lens controller moves the camera lens 110 to the lens position indicated as “OUT,” the height of the image of scene 102 is indicated as “hout.” Since the height hout is less than the height hin, the image looks like it is being zoomed out while the auto focus circuit (not shown) performs focusing. This zooming in and zooming out effect based on magnification as the lens position changes causes lens breathing. As described earlier, a compensation circuit can use magnification scaling factors found during offline calibration to update radial distances of the image data to reduce lens breathing.

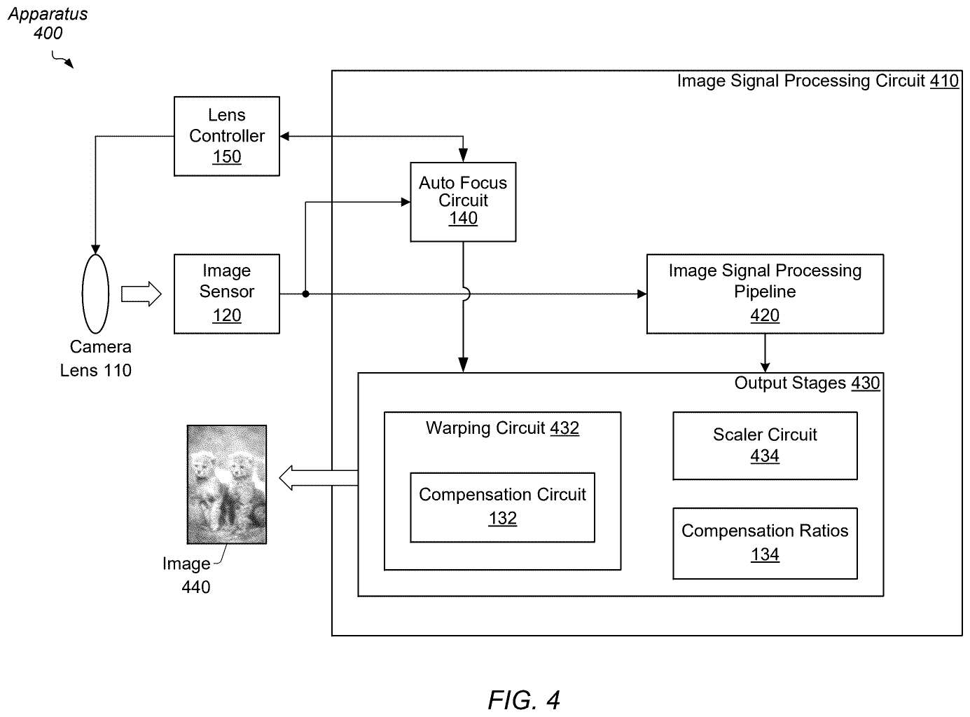

Referring to FIG. 4, a generalized diagram is shown of one implementation of an apparatus 400 that efficiently performs auto focusing while reducing lens breathing. Circuits and components previously described are numbered identically. The lens controller 150 transitions the camera lens 110 to different lens positions. The image sensor 120 captures the optical signals, such as light 114 (or light waves), that pass through the camera lens 110 and converts the optical signals into analog electrical signals. The auto focus circuit 140 and the image signal processing pipeline 420 of the image signal processing circuit 410 receive the analog electrical signals. In an implementation, the functionality of the image signal processing circuit 410 is performed by a single processing circuit (or processor), whereas, in another implementation, the functionality of the image signal processing circuit 410 is performed by multiple processing circuits.

The image signal processing pipeline 420 includes multiple blocks of circuitry that perform a variety of image signal processing. Examples of the image signal processing are performing black level balancing, performing white balance gain, performing denoising of Bayer color filter array (CFA) data, performing demosaicing to interpolate the CFA data to form a full-color image, performing gamma correction, performing tone mapping, performing conversion between the pixel color values used to represent the red, green, and blue color values (RGB values) and luma or brightness (Y) values, blue (U) color values (U) and red (V) color values (YUV values). In addition, other examples of the image signal processing are performing YUV denoising and sharpness enhancing. The image signal processing pipeline 420 sends its output values to the output stages 430, which provides the image 440.

The output stages 430 include the scaler circuit 434, the warping circuit 432, the compensation circuit 132, and the compensation ratios 134. The scaler circuit 434 performs resizing of the image and enhances resolution. In some implementations, the warping circuit 432 includes the compensation circuit 132. In other implementations, compensation circuit 132 is located externally from warping circuit 432. The warping circuit 432 removes distortion of the image. Typically, the warping circuit 432 adjusts radial distances of multiple points on the image to remove distortion. In some cases, based on input from the user, the warping circuit 432 adjusts radial distances of multiple points on the image to add distortion for image manipulation for entertainment reasons.

The warping circuit 432 receives output data from the scaler circuit 434 and performs steps to remove distortion. Afterward, the warping circuit 432 provides the image 440. In various implementations, compensation circuit 132 generates warp vectors based on compensation ratios 134 and provides the warp vectors to warping circuit 432. In various implementations, image 440 provides an image as if the lens position is located at the reference lens position such as the macro lens position. In other implementations, another lens position other than the macro lens position is selected to be the reference lens position. The generation of image 440 based on compensation circuit 132 reduces lens breathing during auto focusing steps.

Turning now to FIG. 5, a generalized diagram is shown of an implementation of warping correction 500. A warping circuit receives image 510, performs radial distance adjustment 520, and provides the image 530. The warping circuit performs a radial distance adjustment operation to correct lens distortion. The warping circuit receives image 510 from a compensation circuit, which is used to efficiently perform auto focusing while reducing lens breathing. It is noted that although each of the compensation circuit and the warping circuit performs adjustments of radial distances of points across the image, these operations are separate operations. The radial distance adjustment operation performed by the warping circuit occurs after the compensation operation performed by the compensation circuit. Each of the points across image 510 is represented as a black dot on image 510 and has a radial distance between a corresponding black dot and the center of the image 510. Four quadrants or regions are labeled with the notations “1,” “2,” and so forth.

The areas of image 510 nearest the outside edges of image 510 have the most lens distortion. The warping circuit adjusts the radial distances to remove lens distortion. A warp vector includes a radial distance. In some implementations, the warp vector includes the x-direction component and the y-direction component for defining the radial distance. As shown, a radial distance R corresponding to an area near the edge of image 510 is reduced to a radial distance R′ by the warping circuit. The lighter dots shown in the radial distance adjustment 520 illustrate the original positions of points of image 510, and the darker dots shown in the radial distance adjustment 520 illustrate the updated positions of points of image 510. The warper circuit provides image 530 as output using the adjusted radial distances provided by the warp vectors.

Referring to FIG. 6, a generalized diagram is shown of an implementation of radial distance correction 600. A compensation circuit of a warping circuit uses a checkerboard patterned design of board 610 as a test image. Each of the points across board 610 used as the test image is represented by a corner of one of the multiple black and white squares across board 610. In various implementations, each of these squares has the same dimensions and corresponds to a particular resolution of a screen. In other implementations, board 610 uses a different pattern. For example, rectangles with a horizontal dimension different from its vertical dimension can be used. While a pattern using squares or rectangles is described, any of a variety of patterns can be used and are contemplated. Each point has a radial distance between a corresponding corner of a square (or block) and the center of the board 610. Board 620 includes the checkerboard, but the checkerboard is magnified compared to board 610. In various implementations, board 610 is the test image at the first intermediate lens position (Lens Position 1) that is closer to the infinity lens position than the second intermediate lens position (Lens Position 2) of board 620. Board 620 is the test image at Lens Position 2 that is closer to the macro lens position than Lens Position 1 of board 610.

In an implementation, the first radial distance, r1, is measured from the center of the checkerboard to a point that is one and a half squares up and two squares to the left from the center of the checkerboard. This radial distance is shown as radial distance r1′ in board 610 and as radial distance r1″ in board 620. The radial distance r1″ of board 620 is greater than the radial distance r1′ of board 610. The radial distance r1 is measured as r1i at the infinity lens position and radial distance r1 is measured as r1im at the macro lens position. The radial distance r1′ of board 610 is greater than the radial distance r1i at the infinity lens position. The radial distance r1im at the macro lens position is greater than the radial distance r1″ of board 620. Radial distances r2 and r3 are also shown as measured radial distances r2′ and r3′ in board 610 and shown as measured radial distances r2″ and r3″ in board 620. The same size relations exist with corresponding radial distances in boards 610 and 620 and at the infinity lens position and the macro lens position. These values are used to generate compensation ratios, which the compensation circuit uses to reduce lens breathing during auto focusing steps. Prior to the warping circuit reducing lens distortion, the compensation circuit uses the compensation ratios to reduce lens breathing during auto focusing steps. The radial distance adjustment operation performed by the warping circuit is a separate operation from the compensation operation performed by the compensation circuit using the compensation ratios.

The checkerboard has multiple radial distances. For example, when squares are used, the checkerboard has X total horizontal squares (of alternating colors (e.g., black and white) and Y total vertical squares of alternating colors. Therefore, the checkerboard has ((X+1)×(Y+1)) radial distances from the center of the checkerboard to corners of the squares. Here, each of X and Y is a positive, non-zero integer. In the illustrated implementation, the checkerboard includes 8 total horizontal squares of alternating colors (e.g., black and white) and 5 total vertical squares of alternating colors. This checkerboard has 54 radial distances, since (8+1)×(5+1)=54. Each of board 610 and board 620 has 54 radial distances from the center of the checkerboard to corners of the squares. The compensation circuit measures these 54 radial distances at multiple lens positions.

The infinity lens position has a measured radial distance for radial distance r1 equal to r1i. The magnification scaling factor for radial distance r1 at the infinity lens position is (r1i/r1i), or 1. At the infinity lens position, the magnification scaling factor for each of the radial distances is 1. At Lens Position 1, the magnification scaling factor for radial distance r1 is (r1′/r1i), which is greater than 1. In an implementation, the measured radial distance for radial distance r1 at the infinity lens position is r1i=2.5424 inches. The measured radial distance for radial distance r1 at Lens Position 1 of board 610 is r1′=2.6949 inches. Therefore, the magnification scaling factor for radial distance r1 at Lens Position 1 is (r1′/r1i), or (2.6949 inches/2.5424 inches), or 1.06. The compensation circuit or test circuitry performs similar measurements for other radial distances of board 610. The compensation circuit or test circuitry performs similar measurements for radial distances of board 620 at Lens Position 2 and for radial distances of the checkerboard at other lens positions such as the macro lens position.

In some implementations, the macro lens position is selected as the reference lens position to be used to generate the compensation ratios. The compensation ratios are used to reduce lens breathing during auto focus steps. Using radial distances and using the macro lens position as the reference lens position to generate the compensation ratios, the compensation ratio for radial distance r1′ of board 610 at Lens Position 1 is (r1m/r1′), which can be measured as (2.8983 inches/2.6949 inches), or 1.0755 or 1.08. Therefore, the compensation ratios are used to adjust radial distances at a particular lens position to have the image appear as if the lens position is located at the reference lens position. In an implementation, the reference lens position is the macro lens position.

Storing the magnification scaling factors, rather than the radial distances, of different lens positions can use less data storage and the magnification scaling factors can be used to generate compensation ratios. For example, using magnification scaling factors, the magnification scaling factor of the radial distance r1 at the macro lens position is (r1m/r1i), which can be measured as (2.8983 inches/2.5424 inches) or 1.14. The magnification scaling factor at Lens Position 1 is (r1′/r1i), which is (2.6949 inches/2.5424 inches) or 1.06. The compensation ratio for radial distance r1 at Lens Position 1 is the magnification scaling factor of the macro lens position divided by the magnification scaling factor at Lens Position 1, which is (1.14/1.06), or 1.0755 or 1.08. The choice of using stored values of radial distances or magnification scaling factors for generating compensation ratios is based on design requirements.

The compensation circuit or test circuitry performs similar measurements for compensation ratios of board 620 at Lens Position 2 and for compensation ratios of the checkerboard at other lens positions. As shown in the illustrated implementation, at Lens Position 2, the compensation ratio for radial distance r1 is (r1m/r1i)/(r1″/r1i), which is (r1m/r1″). Either stored magnification scaling factors or stored radial distances can be used to generate the compensation ratios. Typically, each of the magnification scaling factor and the compensation ratio of radial distance r3 is different from corresponding values of radial distance r2 and radial distance r1. Therefore, at each lens position, the compensation circuit or test circuitry can generate 54 different compensation ratios. The compensation circuit stores the generated compensation ratios at different lens positions for dynamic reduction of lens breathing during auto focus steps. When a later selected lens position is between lens positions used for offline calibration, such as a later selected lens position is between Lens Position 1 and Lens Position 2, the compensation circuit can use interpolation of the stored compensation ratios. Any of a variety of interpolation formulas can be used. It is noted that in some implementations, another lens position is selected as the reference lens position other than the infinity lens position to be used to generate the magnification scaling factors. Additionally, in some implementations, another lens position is selected as the reference lens position other than the macro lens position to be used to generate the compensation ratios.

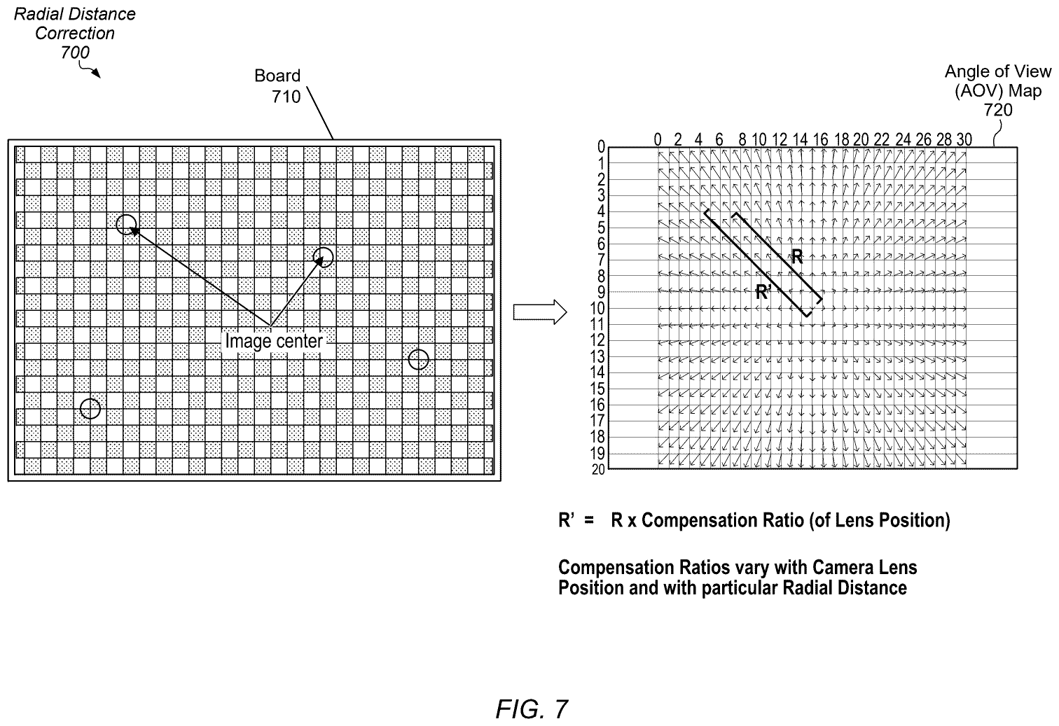

Referring to FIG. 7, a generalized diagram is shown of an implementation of radial distance correction 700. During an offline calibration process, the checkerboard (or chess board) design of board 710 is used to identify locations of multiple points across the image. Each of the points across the image is represented by a corner of one of the multiple black and white squares across board 710 as described earlier regarding board 610 (of FIG. 6). In various implementations, each of these squares has the same dimensions and corresponds to a particular resolution of a screen. In other implementations, board 710 uses rectangles with a horizontal dimension different from its vertical dimension. Each point has a radial distance between a corresponding corner of a square and the center of the board 710, which corresponds to the center of the image. The angle of view (AOV) map 720 shows the different magnification levels across the image. The arrows of AOV map 720 indicate the magnification levels. The areas of an image nearest the outside edges of the image have the higher magnification levels, and therefore, have the most distortion. The magnification levels are based on both the radial distances and the currently used lens position. Therefore, the magnification levels are based on two variables.

AOV map 720 includes multiple points, each with a respective radial distance from the center of AOV map 720. In various implementations, AOV map 720 is a warping grid. In some implementations, the warping grid (or AOV map 720) has the same size and the same number of points as board 710. In other implementations, the warping grid (or AOV map 720) has a different size and a different number of points than board 710. The compensation circuit adjusts the radial distances used to identify points in board 710 to reduce lens breathing. The compensation circuit can also generate warp vectors based on the adjusted radial distances. The warping circuit receives the generated warp vectors and uses the warp vectors to identify points in AOV map 720 (the warp grid). When AOV map 720 has a different size than the size of board 710, the compensation circuit uses interpolation of the updated radial distances of board 710 to generate radial distances of the warp vectors of AOV map 720. Any of a variety of interpolation formulas can be used. The compensation circuit can also generate the x-direction components and y-direction components of the generated radial distances of the AOV map 720 to generate the warp vectors. As shown, a radial distance R is adjusted to a radial distance R′. Magnification scaling factors and compensation ratios are generated during an offline calibration process that measures magnification of radial distances of an image for different lens positions. Each of the magnification scaling factors is a scaling factor between one of a first set of multiple radial distances of the currently used lens position and a corresponding one of a second set of multiple radial distances of a reference lens position.

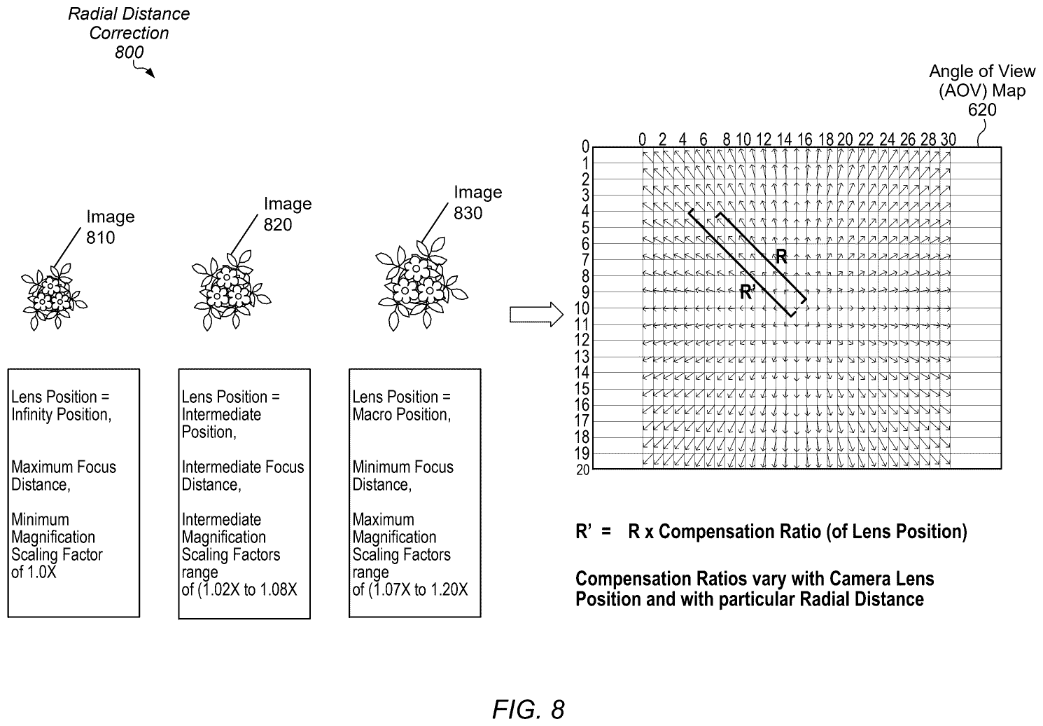

Turning now to FIG. 8, a generalized diagram is shown of an implementation of radial distance correction 800. Circuitry and components described earlier are numbered identically. As described earlier, the angle of view (AOV) map 620 shows the different magnification levels across the image. The arrows of AOV map 620 indicate the magnification levels. The areas of an image nearest the outside edges of the image have the higher magnification levels, and therefore, have the most distortion. The magnification levels are based on both the radial distances and the currently used lens position. Therefore, the magnification levels are based on two variables. Each of image 810, image 820, and image 830 represents optical signals, such as light (or light waves), that pass through the camera lens located at a different lens position from one another and are captured by an image sensor. In an implementation, the lens position corresponding to image 810 is a reference lens position, which is an infinity lens position corresponding to a maximum focus distance and a minimum magnification of a scene. The magnification scaling factor of image 810 corresponding to the infinity lens position is 1.0. As described earlier regarding the radial distance correction 600 (of FIG. 6), the magnification scaling factor for any radial distance at the infinity lens position is 1. For example, at the infinity lens position, the magnification scaling factor for radial distance r1 is (r1i/r1i), or 1.

In an implementation, the lens position corresponding to image 830 is a macro lens position corresponding to a minimum focus distance and a maximum magnification of a scene. In the illustrated implementation, the magnification scaling factors of image 830 has a range from 1.07× to 1.20×. These values are used for illustrative purposes and be any values in various implementations. Therefore, other magnification scaling factors based on the particular camera image signal processing system are possible and contemplated. In an implementation, the lens position corresponding to image 820 is an intermediate lens position, which is between the infinity lens position and the macro lens position. The intermediate lens position corresponds to an intermediate focus distance and an intermediate magnification of a scene. In the illustrated implementation, the magnification scaling factors of image 820 has a range from 1.02× to 1.08×. These values are used for illustrative purposes and be any values in various implementations.

As shown, a radial distance R corresponding to a particular point on the image is increased to a radial distance R′ by the compensation circuit. The compensation circuit uses compensation ratios to generate the updated radial distances of the present used lens position. As described earlier, the compensation circuit stores the compensation ratios that were generated during an earlier offline calibration process. The compensation circuit can also generate warp vectors based on the adjusted radial distances of the checkerboard test image. In an implementation, the warping grid has the same size and the same number of radial distances as the checkerboard test image. In such an implementation, the compensation circuit sends the updated radial distances of the presently used lens position to the warping circuit. In other implementations, the compensation circuit generates x-direction components and y-direction components of the updated radial distances. The warping circuit receives the generated warp vectors and uses the warp vectors to remove distortion.

In yet other implementations, the warping grid has a different size and a different number of radial distances than the checkerboard test image. For example, the warping grid is larger than the checkerboard of the test image. In one example, the checkerboard includes 28 total horizontal squares of alternating colors (e.g., black and white) and 18 total vertical squares of alternating colors, whereas the warping grid includes 32 total horizontal squares and 32 total vertical squares. The compensation circuit can use interpolation of the updated radial distances of the checkerboard to generate radial distances of the warping grid. Any of a variety of interpolation formulas can be used. Following, the compensation circuit generates x-direction components and y-direction components of the generated radial distances of the warping grid to generate the warp vectors. The warping circuit receives the generated warp vectors and uses the warp vectors to remove distortion.

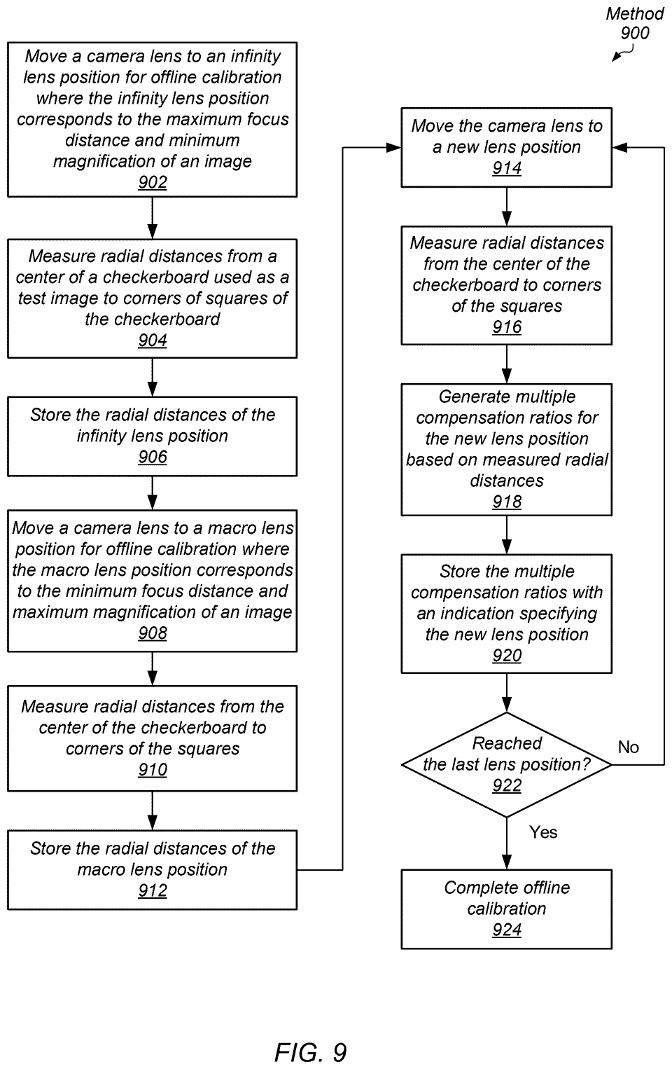

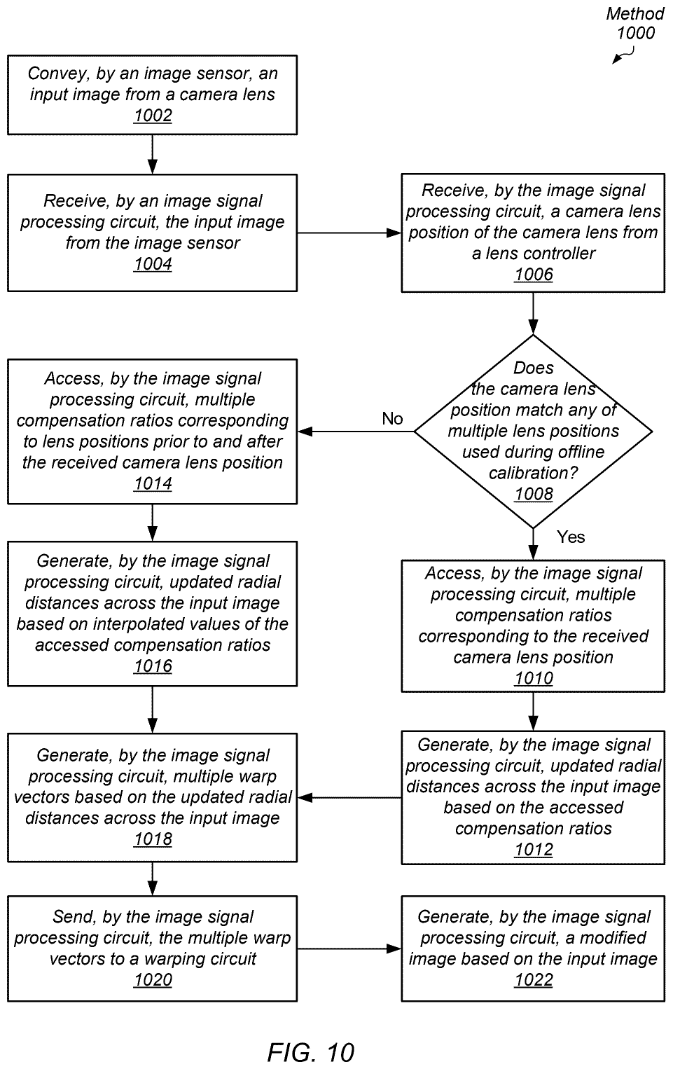

Referring to FIG. 9, a generalized block diagram is shown of a method 900 for performing offline calibration to generate magnification scaling factors used later by auto focus steps that reduce lens breathing. For purposes of discussion, the steps in this implementation (as well as FIG. 10) are shown in sequential order. However, in other implementations some steps occur in a different order than shown, some steps are performed concurrently, some steps are combined with other steps, and some steps are absent.

During offline calibration, one or more indications are sent to a lens controller to move a camera lens to a first lens position to use as a reference position for offline calibration where the first lens position is an infinity lens position corresponding to the maximum focus distance of the camera and minimum magnification of an image (block 902). A compensation circuit of the image signal processing circuit measures radial distances from the center of an image to points of a checkerboard used as a test image (block 904). The points are the corners of the squares of the checkerboard. If a checkerboard has X total horizontal squares of alternating colors (e.g., black and white) and Y total vertical squares of alternating colors, then the checkerboard has ((X+1) x (Y+1)) radial distances from the center of the checkerboard to corners of the squares. Here, each of X and Y is a positive, non-zero integer. In an implementation, the checkerboard includes 30 total horizontal squares of alternating colors (e.g., black and white) and 20 total vertical squares of alternating colors. This checkerboard has 651 radial distances, since (30+1)×(20+1)=651. The checkerboard has 651 radial distances from the center of the checkerboard to corners of the squares. The compensation circuit measures these 651 radial distances. The compensation circuit stores these radial distances corresponding to the infinity lens position (block 906).

During the offline calibration, one or more indications are sent to the lens controller to move the camera lens to a second lens position to use as a reference position for offline calibration where the second lens position is a macro lens position corresponding to the minimum focus distance of the camera and maximum magnification of the test image (block 908). The compensation circuit measures radial distances from the center of the test image (e.g., the checkerboard) to corners of the squares of the checkerboard used as the test image (block 910). The compensation circuit stores these radial distances corresponding to the macro lens position (block 912). In other implementations, the compensation circuit or test circuitry generates magnification scaling factors for the multiple radial distances, and stores the magnification scaling factors, rather than the radial distances. These steps are similar to the description of the radial distance correction 600 (of FIG. 6).

The lens controller is instructed by the compensation circuit, testing circuitry, or other to move the camera lens to a new lens position (block 914). In an implementation, the new lens position is a step size away from the infinity lens position. The compensation circuit, testing circuitry, or other measures radial distances from the center of the test image to points of the checkerboard such as the corners of the squares of the checkerboard (block 916). These points on the checkerboard are used for measuring radial distances at each different lens position. The compensation circuit or test circuitry generates multiple compensation ratios for the new lens position based on the measured radial distances (block 918). In an implementation, the compensation circuit or test circuitry generates the compensation ratio of a first radial distance by dividing the measured first radial distance of the macro position by the measured first radial distance of the new lens position. This ratio is shown in the radial distance correction 600 (of FIG. 6). For example, the new lens position has a measured radial distance for radial distance r1 equal to r1′. The macro lens position has a measured radial distance for radial distance r1 equal to r1m. The compensation ratio for radial distance r1 at the new lens position is (r1m/r1′).

In another implementation, compensation circuit or test circuitry generates multiple magnification scaling factors between the radial distances of the new lens position and corresponding radial distances of the infinity lens position. The compensation circuit or test circuitry generates the magnification scaling factor of a first radial distance by dividing the measured first radial distance of the new lens position by the measured first radial distance of the infinity lens position. This ratio is shown in the radial distance correction 600 (of FIG. 6). For example, the new lens position has a measured radial distance for radial distance r1 equal to r1′. The infinity lens position has a measured radial distance for radial distance r1 equal to r1i. The magnification scaling factor for radial distance r1 at the new lens position is (r1′/r1i). For the macro lens position, the magnification scaling factor for radial distance r1 is (r1m/r1i). The compensation circuit or test circuitry generates the compensation ratio of the first radial distance r1 by dividing the magnification scaling factor of the macro lens position by the magnification scaling factor of the new lens position. Therefore, the compensation ratio for radial distance r1 at the new lens position is ((r1m/r1i)/((r1′/r1i), which is equal to (r1m/r1′).

Storing the magnification scaling factors, rather than the radial distances, of different lens positions can use less data storage. For example, using radial distances, the compensation ratio for radial distance r1 at the new lens position is (r1m/r1′), which can be measured as (2.7021 inches/2.3418 inches), or 1.1539 or 1.15. Using magnification scaling factors, the magnification scaling factor of the macro lens position is (r1m/r1i), which can be measured as (2.7021 inches/2.2518 inches), or 1.20. The magnification scaling factor of the new lens position is (r1′/r1i), which can be (2.3418 inches/2.2518 inches or 1.04. The compensation ratio for radial distance r1 at the new lens position is the magnification scaling factor of the macro lens position divided by the magnification scaling factor of the new lens position, which is (1.20/1.04), or 1.15. The choice of using stored values of radial distances or magnification scaling factors for generating compensation ratios is based on design requirements.

The compensation circuit or test circuitry stores the generated multiple compensation ratios with an indication specifying the new lens position (block 920). If the last lens position has not yet been reached (“no” branch of the conditional block 922), then control flow of method 900 returns to block 914 where the lens controller is instructed to move the camera lens by a step size to a new lens position. If the last lens position has been reached (“yes” branch of the conditional block 922), then offline calibration has completed (block 924).

Turning now to FIG. 10, a generalized block diagram is shown of a method 1000 for efficiently performing auto focusing while reducing lens breathing. An image sensor conveys an input image from a camera lens (block 1002). Each of the image sensor and the camera lens is used within a still camera or a video camera capable of capturing optical data. An image signal processing circuit receives the input image from the image sensor (block 1004). The image signal processing circuit receives a camera lens position of the camera lens from a lens controller (block 1006). If the camera lens position matches any of the multiple lens positions used during offline calibration (“yes” branch of the conditional block 1008), then the image signal circuit accesses multiple compensation ratios corresponding to the received camera lens position (block 1010). The image signal processing circuit generates updated radial distances across the input image based on the accessed compensation ratios (block 1012).

The image signal processing circuit generates multiple warp vectors based on the updated radial distances across the input image (block 1018). The image signal processing circuit sends the multiple warp vectors to a warping circuit (block 1020). The image signal processing circuit generates a modified image based on the input image (block 1022). In various implementations, the modified image provides an image as if the lens position is located at the reference lens position such as the macro lens position. In other implementations, another lens position other than the macro lens position is selected to be the reference lens position. The generation of the modified image reduces lens breathing during auto focusing steps.

If the camera lens position does not match any of the multiple lens positions used during offline calibration (“no” branch of the conditional block 1008), then the image signal circuit accesses multiple compensation ratios corresponding to lens positions prior to and after the received camera lens position (block 1014). The image signal processing circuit generates updated radial distances across the input image based on interpolated values of the accessed compensation ratios (block 1016). Afterward, control flow of method 1000 moves to block 1018 where the image signal processing circuit generates multiple warp vectors based on the updated radial distances across the input image. In various implementations, the compensation ratios, and possibly magnification scaling factors, were calculated during an offline calibration process such as the steps of method 900 (of FIG. 9). These compensation ratios are stored in data storage by the image signal processing circuit. Data storage is provided by flip-flop circuits, one of a variety of random-access memories (RAMs), other types of sequential storage elements, and so forth. By updating the radial distances of the current lens position using the multiple compensation ratios, the image signal processing circuit reduces lens breathing while performing auto focusing.

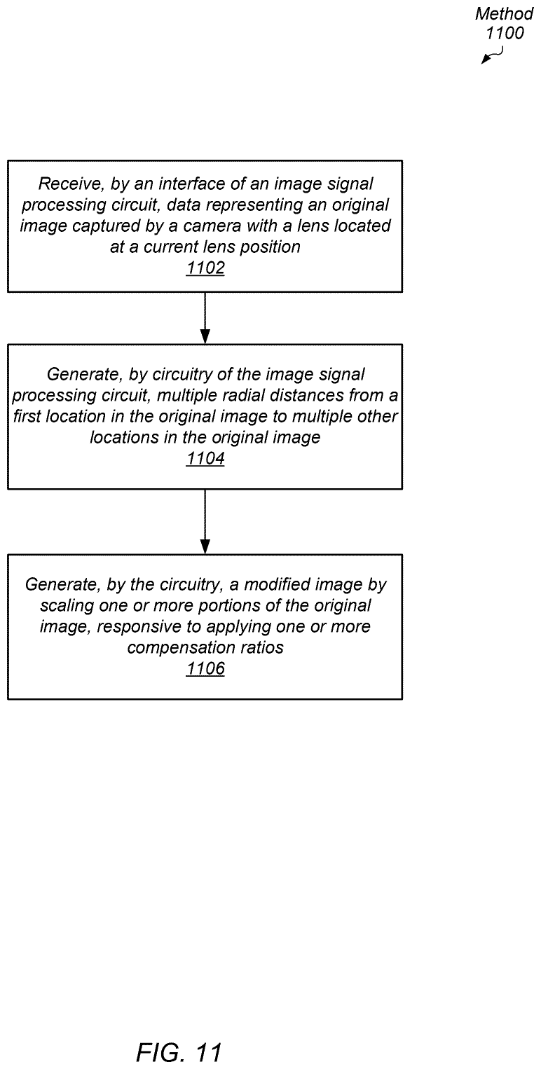

Referring to FIG. 11, a generalized block diagram is shown of a method 1100 for efficiently performing auto focusing while reducing lens breathing. An interface of an image signal processing circuit receives data representing an original image captured by a camera with a lens located at a current lens position (block 1102). The circuitry of the image signal processing circuit generates multiple radial distances from a first location in the original image to multiple other locations in the original image (block 1104). The circuitry generates a modified image by scaling one or more portions of the original image, responsive to applying one or more compensation ratios (block 1106).

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g., synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g., Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high-level programming language such as C, or a design language (HDL) such as Verilog, VHDL, or database format such as GDS II stream format (GDSII). In some cases, the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware based type emulator from such vendors as Cadence®, EVER, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is:

1. A circuit comprising:
an interface configured to receive data representing an original image captured by a camera with a lens located at a first lens position; and
circuitry configured to:
generate a first plurality of radial distances from a first location in the original image to a plurality of other locations in the original image; and
generate a modified image by scaling one or more portions of the original image, responsive to applying one or more compensation ratios.

2. The circuit as recited in claim 1, wherein the one or more compensation ratios are used by the circuitry to scale the one or more portions of the original image.

3. The circuit as recited in claim 1, wherein the one or more compensation ratios correspond to the first plurality of radial distances.

4. The circuit as recited in claim 1, wherein the one or more compensation ratios correspond to one of:
previously stored data; and
an interpolation of the previously stored data.

5. The circuit as recited in claim 1, wherein the modified image corresponds to the lens located at a second lens position different from the first lens position.

6. The circuit as recited in claim 1, wherein the one or more compensation ratios are generated based on a comparison of radial distances generated at a reference lens position to radial distances generated at the first lens position.

7. The circuit as recited in claim 6, wherein the reference lens position corresponds to a minimal focus distance.

8. A method comprising:
receiving, by an interface of an image signal processing circuit, data representing an original image captured by a camera with a lens located at a first lens position;
generating, by circuitry of the image signal processing circuit, a first plurality of radial distances from a first location in the original image to a plurality of other locations in the original image; and
generating, by the circuitry, a modified image by scaling one or more portions of the original image, responsive to applying one or more compensation ratios.

9. The method as recited in claim 8, further comprising using, by the circuitry, the one or more compensation ratios to scale the one or more portions of the original image.

10. The method as recited in claim 8, wherein the one or more compensation ratios correspond to the first plurality of radial distances.

11. The method as recited in claim 8, wherein the one or more compensation ratios correspond to one of:
previously stored data; and
an interpolation of the previously stored data.

12. The method as recited in claim 8, wherein the modified image corresponds to the lens located at a second lens position different from the first lens position.

13. The method as recited in claim 8, wherein the one or more compensation ratios are generated based on a comparison of radial distances generated at a reference lens position to radial distances generated at the first lens position.

14. The method as recited in claim 13, wherein the reference lens position corresponds to a minimal focus distance.

15. An apparatus comprising:
an image sensor configured to convey image data of an image to view based on a lens located at one of a plurality of lens positions;
a lens controller configured to adjust a lens position of the lens; and
an image signal processing circuit comprising:
an interface configured to receive data representing an original image captured by a camera with a lens located at a first lens position of the plurality of lens positions; and
circuitry configured to:
generate a first plurality of radial distances from a first location in the original image to a plurality of other locations in the original image; and
generate a modified image by scaling one or more portions of the original image, responsive to applying one or more compensation ratios.

16. The apparatus as recited in claim 15, wherein the one or more compensation ratios are used by the circuitry to scale the one or more portions of the original image.

17. The apparatus as recited in claim 15, wherein the one or more compensation ratios correspond to the first plurality of radial distances.

18. The apparatus as recited in claim 15, wherein the one or more compensation ratios correspond to one of:
previously stored data; and
an interpolation of the previously stored data.

19. The apparatus as recited in claim 15, wherein the modified image corresponds to the lens located at a second lens position different from the first lens position.

20. The apparatus as recited in claim 15, wherein the one or more compensation ratios are generated based on a comparison of radial distances generated at a reference lens position to radial distances generated at the first lens position.
